(19) United States
(12) Patent Application Publication
(10) Pub. No.: US 2014/0138981 A1
(43) Pub. Date: May 22, 2014

(54) Sunshade Assembly

(71) Applicant: MACAUTO INDUSTRIAL CO. LTD., Tainan City (TW)

(72) Inventor: Paul Lin, Tainan City (TW)

(73) Assignee: MACAUTO INDUSTRIAL CO. LTD., Tainan City (TW)

(21) Appl. No.: 13/680,621

(22) Filed: Nov. 19, 2012

(51) Int. Cl. B60J 3/02

(52) U.S. Cl. CPC B60J 3/0204
USPC 296/97.4

(57) ABSTRACT

A sunshade assembly to be disposed in a housing unit at a bottom of a vehicle window comprises a shade member having a free end portion adapted to extend outwardly from the housing unit through the slot, a side bar unit, a driving unit, and a pair of guiding units. The side bar unit includes a side bar member connected to the free end portion of the shade member, and a cover member removably connected to the side bar member for covering the slot. The driving unit drives the side bar unit to move the shade member between a retracted state and an extended state. Each guiding unit includes a wheel that contacts rotatably on the vehicle window when the shade member is moved toward or away from the retracted state.

### BACKGROUND OF THE INVENTION

1. Field of the Invention

This invention relates to a sunshade assembly, more particularly to a sunshade assembly comprising a shade member with a free end portion and a side bar unit disposed on the free end portion of the shade member.

2. Description of the Related Art

As shown in FIGS. 1 and 2, a conventional sunshade assembly 1 is adapted to be mounted to a housing unit 10 that is disposed at the bottom of a rear windshield of an automobile. The housing unit 10 includes a first engaging plate 101 and a second engaging plate 102 cooperating with the first engaging plate 101 to define a slot 103 that extends in a longitudinal direction. The sunshade assembly 1 comprises a hollow stationary seat 11 adapted to be disposed under the housing unit 10, a retractable shade member 12 having a free end portion 121 that is adapted to extend outwardly from the housing unit 10 through the slot 103, a side bar unit 13 disposed on the free end portion 121 of the shade member 12, and a driving unit 14 for driving movement of the side bar unit 13 so as to move the shade member 12 between an extended state, where the shade member 12 extends outwardly from the housing unit 10, and a retracted state, where the shade member 12 is received by the housing unit 10.

The side bar unit 13 is made integrally of plastic through molding and has a cover portion 131 extending in the longitudinal direction and a pair of side wall portions 132 extending separately from the cover portion 131 toward the stationary seat 11. When the shade member 12 is at the retracted state, the side bar unit 13 is in contact with the housing unit 10, the side wall portions 132 extend into the slot 131, and the cover portion 131 abuts against the first and second engaging plates 101, 102. The cover portion 131 has a width that is wider than the width of the slot 103 so that it may fully cover the slot 103 so as to prevent dust from falling into the housing unit 10. One of the side wall portions 132 defines a groove 133 to be engaged with the free end portion 121 of the shade member 12. The driving unit 14 includes a driving component 141 mounted on the stationary seat 11 and a pair of foldable arms 142 interconnecting the driving component 141 and the side bar unit 13.

While using the conventional sunshade assembly 1, the driving component 141 drives the arms 142 to fold and unfold, which causes the side bar unit 13 to respectively move towards and away from the stationary seat 11, thereby moving the shade member 12 between the retracted state and the extended state, respectively.

During installation of the housing unit 10 and the conventional sunshade assembly 1 on an automobile, because of the integrally formed structure of the side bar unit 13 and the relatively wide cover portion 131, the first engaging plate 101 is usually installed first, followed by installation of the conventional sunshade assembly 1 and then installation of the second engaging plate 102. However, the conventional sunshade assembly 1 is not applicable when the housing unit 10 is also integrally formed.

Also, because the rear windshield usually inclines upwardly towards the front of the automobile and is slightly curved in shape, and the side bar unit 13 of the conventional sunshade assembly 1 is supported merely by the pair of arms 142, when the shade member 12 is at the extended state during movement of the automobile, the shade member 12 may vibrate such that the side bar unit 13 collides with the rear windshield resulting in noise and scratches on the rear windshield.

### SUMMARY OF THE INVENTION

Therefore, one aspect of the present invention is to provide a sunshade assembly that is easy to install and that is compatible with more vehicles.

Another aspect of the present invention is to provide a sunshade assembly that prevents noise and scratches on the windows during use.

Accordingly, a sunshade assembly of the present invention is adapted to be disposed in a housing unit, which is formed with a slot at a bottom of a vehicle window, and comprises:

a hollow stationary seat that is adapted to be disposed under the housing unit;

a shade member that has a connecting end portion secured to the stationary seat and a free end portion opposite to the connecting end portion, and that is movable between a retracted state, where the shade member is retracted into the housing unit, and an extended state, where the free end portion extends outwardly from the housing unit through the slot;

a side bar unit that includes a side bar member that is connected to the free end portion of the shade member and that has opposite ends, and a cover member that is removably connected to the side bar member and that has a portion adapted to be disposed outside of the housing unit to separably cover the slot when the shade member is at the retracted state;

a driving unit that is connected to the side bar unit for driving the side bar unit to move the shade member between the retracted state and the extended state; and

a pair of guiding units, each of which includes a side plug connected to a respective one of the opposite ends of the side bar member, a wheel seat connected pivotally to the side plug, a wheel mounted rotatably on the wheel seat, and a resilient member disposed between the side plug and the wheel seat for biasing the wheel seat to pivot relative to the side plug toward an unfolded position such that the wheel contacts rotatably on the vehicle window when the shade member is away from the retracted state.

### BRIEF DESCRIPTION OF THE DRAWINGS

Other features and advantages of the present invention will become apparent in the following detailed description of the preferred embodiments with reference to the accompanying drawings, of which:

FIG. 1 is a perspective view of a conventional sunshade assembly;

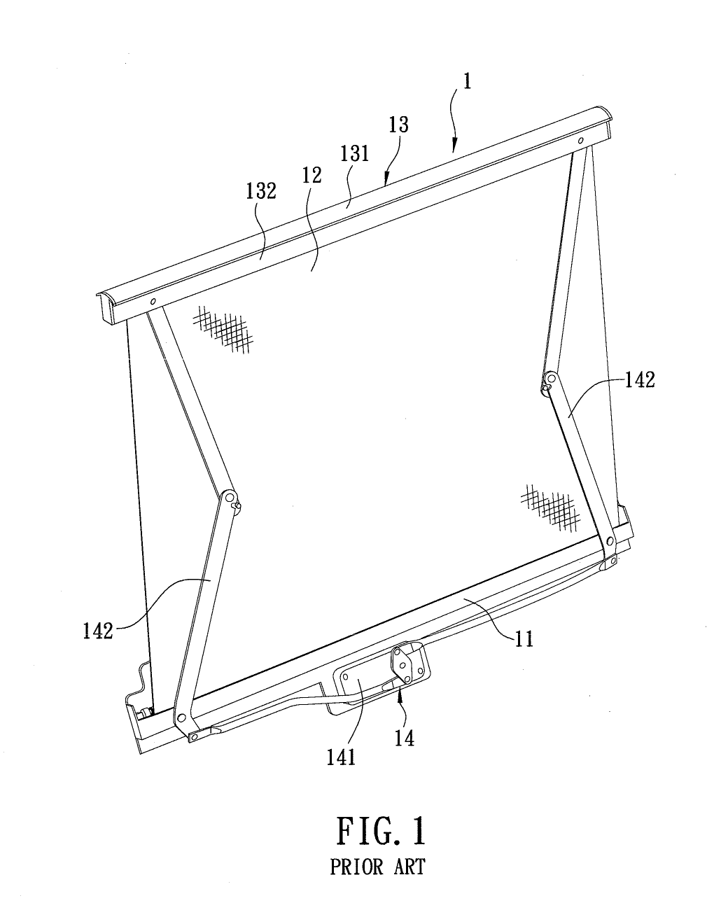

FIG. 2 is a fragmentary sectional view of the conventional sunshade assembly;

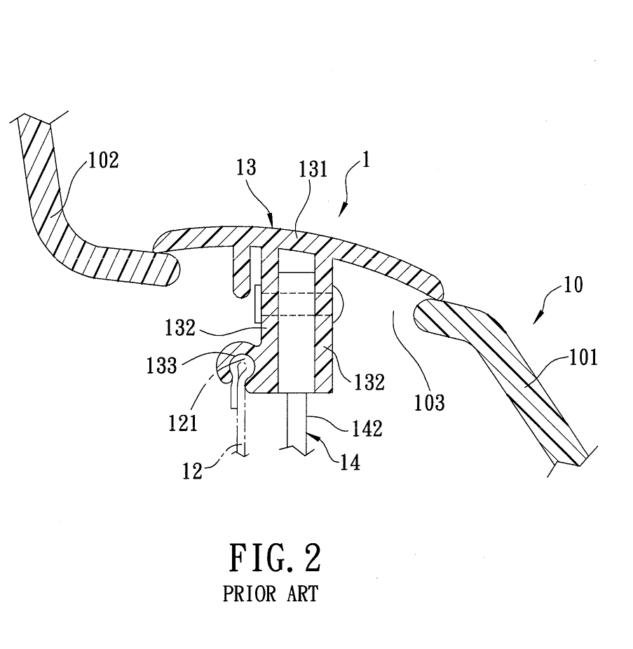

FIG. 3 is a perspective view of a first preferred embodiment of a sunshade assembly according to present invention;

FIG. 4 is a fragmentary exploded perspective view of the first preferred embodiment, illustrating a side bar unit and a guiding unit of the sunshade assembly;

FIG. 5 is a fragmentary sectional view of the first preferred embodiment when a shade member is at a retracted state;

FIG. 6 is a fragmentary sectional view of the first preferred embodiment when the shade member is at an extended state;

FIG. 7 is a sectional view of the first preferred embodiment when the shade member is at the retracted state;

FIG. 8 is a fragmentary exploded perspective view of a second preferred embodiment of the sunshade assembly according to present invention; and

FIG. 9 is a fragmentary sectional view of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

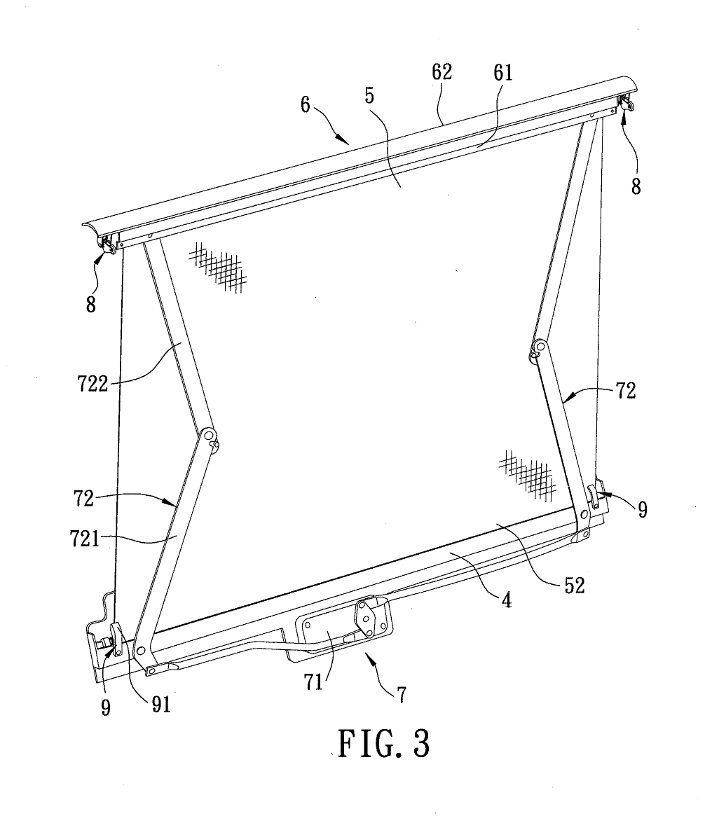

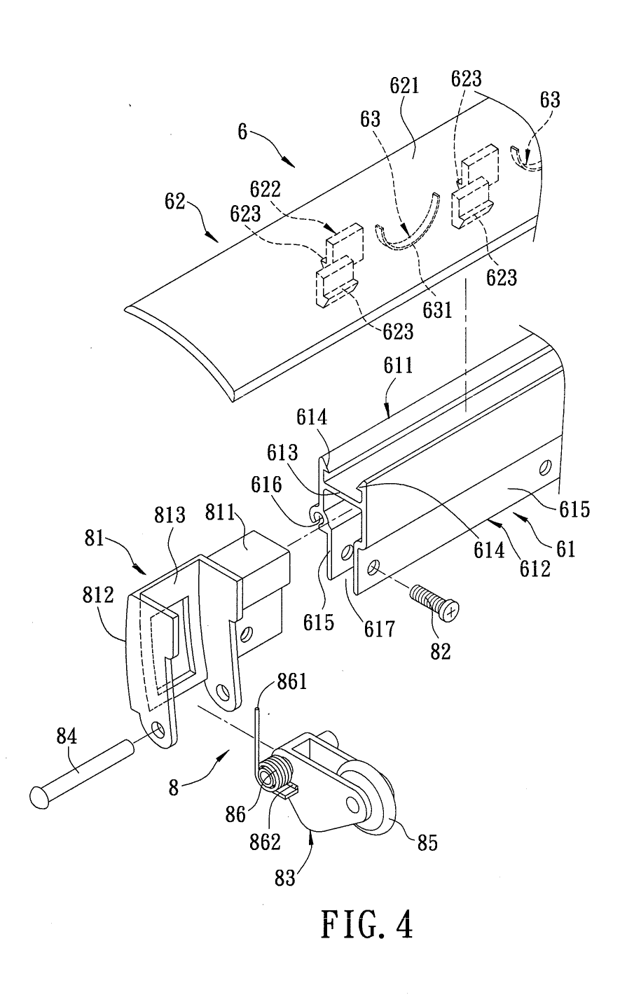

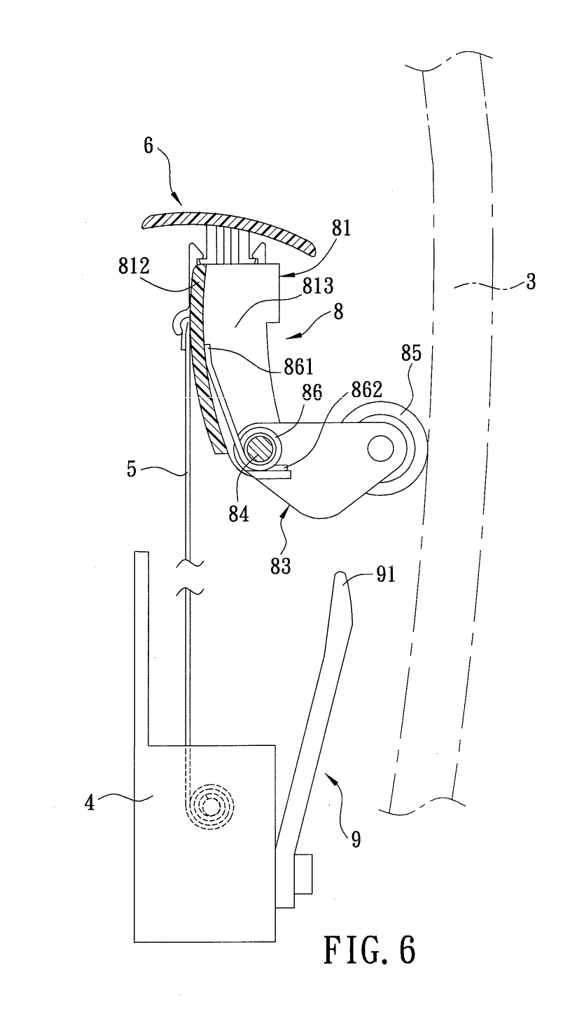

As shown in FIGS. 3, 4, and 5, the first preferred embodiment of a sunshade assembly according to the present invention is adapted to be disposed in a housing unit 2 of a vehicle adjacent to a window 3 (see FIG. 6). In this embodiment, the window 3 refers to a rear windshield of an automobile. However the window 3 may also be a side window or a front windshield of the automobile. The housing unit 2 is formed with a slot 21 that is near the base of the window 3 and that extends in a longitudinal direction with respect to the window 3.

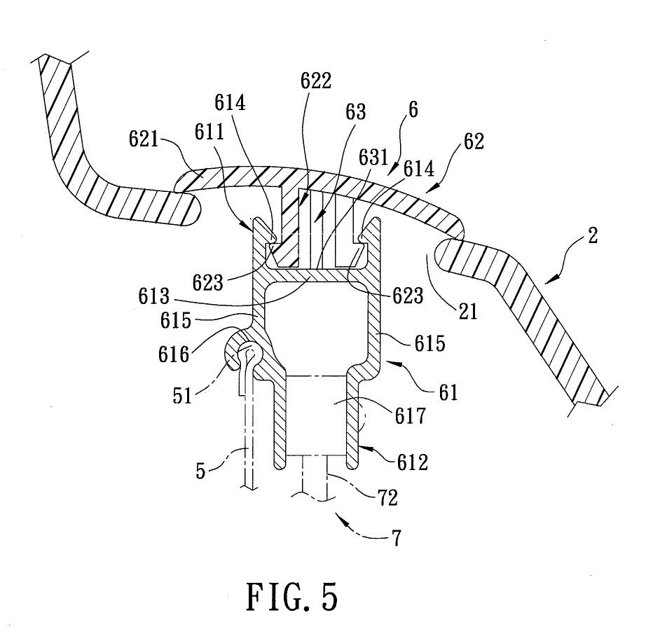

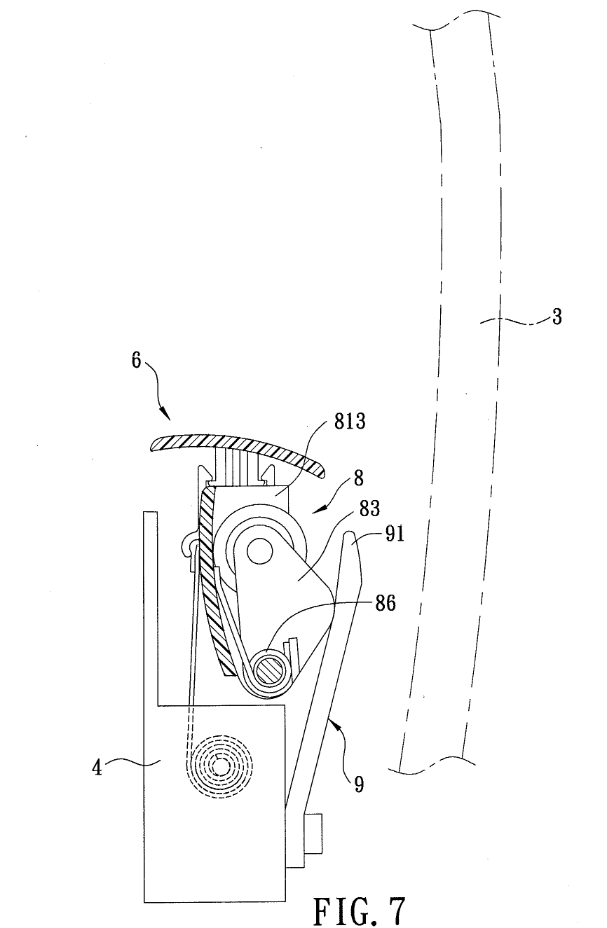

The sunshade assembly comprises a hollow stationary seat 4 adapted to be disposed under the housing unit 2, a shade member 5 having a connecting end portion 52 that is secured to the stationary seat 4 and a free end portion 51 that is opposite to the connecting end portion 4, a side bar unit 6 connected to the free end portion 51 of the shade member 5, and a driving unit 7 connected to the side bar unit 6 for moving the shade member 5 between a retracted state (see FIGS. 5 and 7), where the shade member 5 is received by the housing unit 2, and an extended state (see FIG. 6), where a portion of the shade member 5 is drawn out of the housing unit 2. Also, the sunshade assembly comprises an axle (not shown) that is disposed rotatably in the stationary seat 4, that is secured to the connecting end 52 of the shade member 5, and that is used to roll up the shade member 5, and a torsion spring (not shown) that biases the axle to roll up the shade member 5. Since the configuration of the stationary seat 4 is not significant to the features of the present invention, further details of the stationary seat 4 are omitted herein for the sake of brevity.

The side bar unit 6 includes a side bar member 61 that is connected to the free end portion 51 of the shade member 5 and that has opposite ends in the longitudinal direction, a cover member 62 that is connected removably to the side bar member 61, and a plurality of buffer members 63 that are disposed between the side bar member 61 and the cover member 62.

The side bar member 61 has a cover connecting portion 611 connected removably to the cover member 62 and an installation portion 612 connected pivotally to the driving unit 7. The cover connecting portion 611 has an intermediate wall 613 that extends in the longitudinal direction and that has opposite edges in a transverse direction transverse to the longitudinal direction, and a pair of spaced-apart first hook members 614 that are disposed on the intermediate wall 613 and that extend in the transverse direction. In this embodiment, the top of the first hook members 614 hook inwardly toward each other. The installation portion 612 has a pair of side walls 615 extending respectively from the opposite edges of the intermediate wall 613 toward the driving unit 7. One of the side walls 615 has a groove 616 that is engaged with the free end portion 51 of the shade member 5. The intermediate wall 613 cooperates with the side walls 615 to define an installation space 617 thereamong.

The cover member 62 has a cover segment 621 and coupling segment 622 that is disposed under the cover segment 621 and that is connected removably to the cover connecting portion 611 of the side bar member 61. The cover segment 621 is configured as a long plate extending in the longitudinal direction. Preferably, the cover segment 621 is larger than the slot 21. The coupling segment 622 has a plurality of second hook members 623 mounted on the cover segment 621 and separately engage the first hook members 614 of the cover connecting portion 611 of the side bar member 61. The second hook members 623 in this embodiment are configured as spaced-apart pairs extending from the cover segment 621 toward the intermediate wall 613, where each pair of the second hook members 623 hook outwardly and engage respectively the first hook members 614. The cover connecting portion 611 may also have only one pair of second hook members 623 coupling respectively to the first hook members 614.

The buffer members 63 in this preferred embodiment are formed integrally on the cover member 62. Each of the buffer members 63 is configured as a flexible curved strip, and has a pair of end portions that are connected to the cover segment 621 and a contact portion 631 that is disposed between the side end portions and that abuts against the intermediate wall 613 to ensure that the first hook members 614 are engaged firmly with the second hook members 623. In other embodiments of this invention, the quantity of the buffer member 63 can be altered.

The driving unit 7 includes a driving component 71 disposed on the stationary seat 4 and a pair of side bar connecting units 72 connected pivotally between the driving component 71 and the side bar member 61. Each of the side bar connecting units 72 has a lower arm 721 connected pivotally to the driving component 71 and an upper arm 722 connected pivotally between the lower arm 721 and the side bar member 61. Since the specific configuration of the driving unit 7 is not significant to the present invention and is known in the art, further details of the driving unit 7 are omitted herein for the sake of brevity.

As shown in FIGS. 3, 4, and 6, the sunshade assembly of the present invention further includes a pair of guiding units 8 and a pair of pushing units 9. Each of the guiding units 8 includes a side plug 81 connected to a respective one of the opposite ends of the side bar member 61, a securing member 82 securing the side plug 81 to the side bar member 61, a wheel seat 83 connected pivotally to the side plug 81 at a side of the side plug 81 that faces the window 3, a pivot pin 84 connecting the wheel seat 83 pivotally to the side plug 81, a wheel 85 mounted rotatably on the wheel seat 83, and a resilient member 86 disposed between the side plug 81 and the wheel seat 83 for biasing the wheel seat 83 to pivot relative to the side plug 81 toward an unfolded position (see FIG. 6) such that the wheel 85 contacts rotatably on the window 3.

The side plug 81 of each of the guiding units 8 includes an inserting portion 811 inserted into the installation space 617 of the side bar member 61 and a head portion 812 connected to the inserting portion 811 and abutting against a respective one of the opposite ends of the side bar member 61. The head portion 812 of each of the side plugs 81 has a receiving groove 813 for receiving the wheel seat 83 when the wheel seat 83 is moved from the unfolded position to a folded position (see FIG. 7). The resilient member 86 of each of the guiding units 8 is a torsion spring having a first end 861 that abuts against the side plug 81 and a second end 862 that abuts against the wheel seat 83. Each of the pushing units 9 has a pushing member 91 that is mounted to the stationary seat 4 and that extends upwardly.

When assembling the sunshade assembly, all portions of the sunshade assembly, except for the cover member 62, are first assembled under the housing unit 2. The cover member 62 is then disposed over the slot 21 such that the coupling segments 622 extend into the slot 21 and the second hook members 623 engage with the first hook members 614 of the side bar member 61. As such, the sunshade assembly of the present invention can be applied to automobiles that have integrally-formed housing units 2.

While using the sunshade assembly, when the sidebar unit 6 moves the shade member 5 from the retracted state to the extended state (as shown in FIG. 6), the guiding units 8 are moved respectively away from the pushing units 9 (so that the pushing members 91 extend respectively toward the guiding units 8) and the wheel seats 83 are biased by the respective resilient members 86 to pivot from the folded position to the unfolded position. During the movement of the shade member 5, the wheels 85 contact rotatably on the window 3, follow the gradient of the window 3 to stabilize the side bar unit 6, and maintain sufficient distance between the side bar unit 6 and the window 3 to prevent scratches on the window 3 caused by collision therebetween.

During the movement of the side bar unit 6 to move reversely the shade member 5 from the extended state to the retracted state, the wheels 85 also contact rotatably on the window 3 to stabilize the movement.

When the shade member 5 is moved to the retracted state, the wheel seats 83 are pushed by the respective pushing members 91 to pivot to the folded position against the resilient forces of the resilient members 15-86 and are retained in the respective receiving grooves 813. At this time, the cover member 62 covers separably the slot 21 of the housing unit 2 to prevent from dust falling into the housing unit 2 through the slot 21.

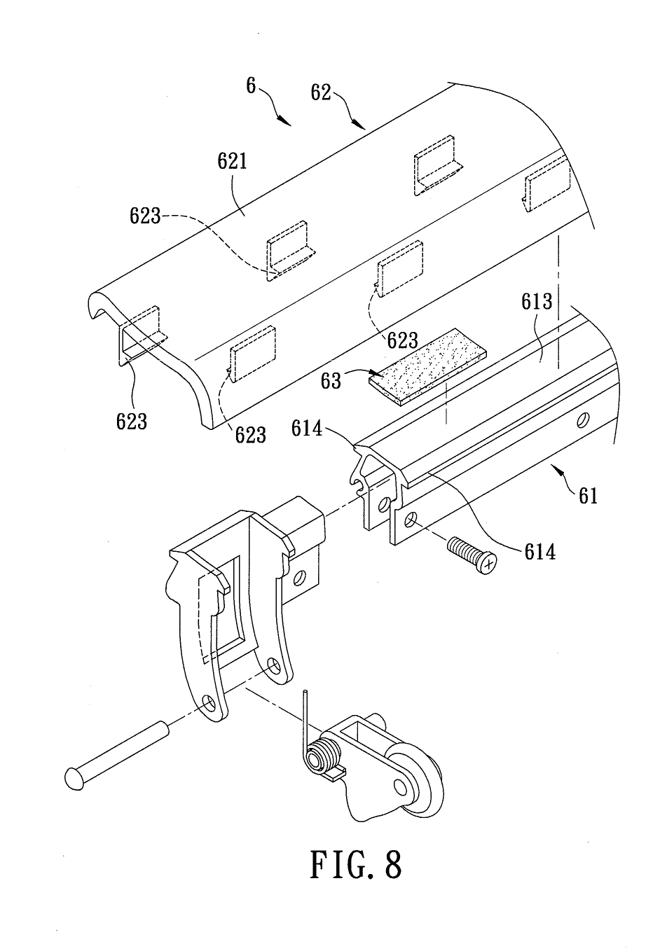

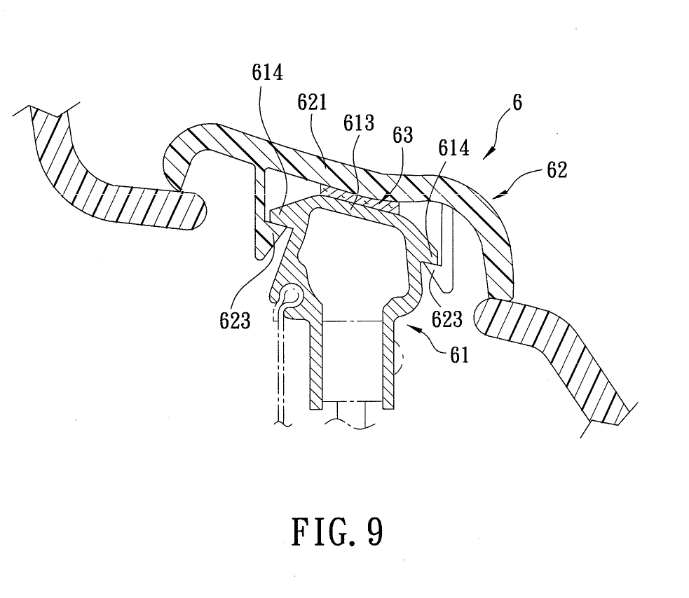

As shown in FIGS. 8 and 9, the second preferred embodiment of the sunshade assembly according to the present invention has similar structure to the first preferred embodiment. The difference between the first preferred embodiment and this preferred embodiment resides in the configuration of the side bar unit 6. Each of the first hook members 614 of the side bar member 61 hooks outwardly away from each other in the transverse direction and the second hook members 623 of the cover member 62 are disposed outside the first hook members 614. The second hook members 623 hook inwardly to removably engage with the first hook members 614.

Additionally, each of the buffer members 63 (only one is shown in FIGS. 8 and 9) of this embodiment is configured as a flexible plate that has opposite surfaces abutting respectively against the intermediate wall 613 and the cover segment 621 of the cover member 62. The buffer members 63 in this embodiment are made of non-woven fabrics but may be made of other materials such as rubber, foam, etc. The buffer members 63 may be mounted on a top surface of the intermediate wall 613 or on a bottom surface of the cover segment 621 of the cover member 62. The second preferred embodiment has the same advantages as those of the first preferred embodiment.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A sunshade assembly adapted to be disposed in a housing unit, which is formed with a slot at a bottom of a vehicle window, said sunshade assembly comprising:
a hollow stationary seat adapted to be disposed under the housing unit;
a shade member having a connecting end portion that is secured to said stationary seat and a free end portion that is opposite to said free end portion, and being movable between a retracted state to be retracted into the housing unit, and an extended state, where said free end portion extends outwardly from the housing unit through the slot;
a side bar unit including
a side bar member that is connected to said free end portion of said shade member and that has opposite ends, and
a cover member that is removably connected to said side bar member, and that has a portion adapted to be disposed outside the housing unit to separably cover the slot when said shade member is at the retracted state;
a driving unit connected to said side bar unit for driving said side bar unit to move said shade member between the retracted state and the extended state; and
a pair of guiding units, each of which includes
a side plug connected to a respective one of said opposite ends of said side bar member,
a wheel seat connected pivotally to said side plug,
a wheel mounted rotatably on said wheel seat, and
a resilient member disposed between said side plug and said wheel seat, and biasing said wheel seat to pivot relative to said side plug toward an unfolded position where said wheel contacts rotatably on the vehicle window when said shade member is away from the retracted state.

2. The sunshade assembly as claimed in claim 1, wherein:
said side bar member has
a cover connecting portion connected removably to said cover member, and
an installation portion connected pivotally to said driving unit and connected to said guiding units; and
said cover member of said side bar unit has
a cover segment adapted to cover the slot of the housing unit when said shade member is at the retracted state, and
a coupling segment disposed under said cover segment and connected removably to said cover connecting portion of said side bar member.

3. The sunshade assembly as claimed in claim 2, the slot extending in a longitudinal direction, wherein:
said cover connecting portion of said side bar member includes
an intermediate wall extending in the longitudinal direction, and
a pair of first hook members disposed on said intermediate wall and spaced apart from each other in a transverse direction transverse to the longitudinal direction; and
said coupling segment of said cover member has at least one second hook member mounted on said cover segment and engaging separably said first hook members of said cover connecting portion of said side bar member.

4. The sunshade assembly as claimed in claim 3, wherein said side bar unit further has at least one buffer member disposed between the side bar member and the cover member, configured as a flexible curved strip, and having a pair of end portions that are connected to said cover segment of said cover member and a contact portion disposed between said end portions and abutting against said intermediate wall.

5. The sunshade assembly as claimed in claim 3, wherein said side bar unit further has at least one buffer member disposed between said side bar member and said cover member, and configured as a flexible plate that has opposite surfaces abutting respectively against said intermediate wall and said cover segment of said cover member.

6. The sunshade assembly as claimed in claim 3, wherein:
said intermediate wall of said cover connecting portion of said side bar member has opposite edges in the transverse direction;
said opposite ends of said side bar member are in the longitudinal direction;
said installation portion of said side bar member has a pair of side walls extending respectively from said opposite edges of said intermediate wall, connected to said driving unit, and cooperating with said intermediate wall to define an installation space;
said side plug of each of said guiding units includes
an inserting portion inserted into said installation space, and
a head portion connected to said inserting portion and abutting against a respective one of said opposite ends of said side bar member; and
each of said guiding units further includes a securing member for securing said inserting portion to said installation portion of said side bar member.

7. The sunshade assembly as claimed in claim 6, wherein one of said side walls has an engaging groove that is engaged with said free end portion of said shade member.

8. The sunshade assembly as claimed in claim 6, wherein:
said head portion of each of said side plugs has a receiving groove for receiving said wheel seat when said wheel seat is moved from the unfolded position to a folded position during the movement of said shade member from the extended state to the retracted state;
said sunshade assembly further comprises a pair of pushing units mounted to said stationary seat, each of said pushing units including a pushing member that extends toward a respective one of said guiding units when said shade member is at the extended state;
said guiding units are away from said pushing units when said shade member is at the extended state; and
said wheel seat of each of said guiding units is pushed by said pushing member of the respective one of said pushing units to pivot from the unfolded position to the folded position and is retained in the respective one of said receiving grooves when said shade member is at the retracted state.

9. The sunshade assembly as claimed in claim 1, wherein:
each of said guiding units further includes a pivot pin that connects pivotally said wheel seat to said side plug; and
said resilient member of each of said guiding units is a torsion spring having a first end that abuts against said side plug and a second end that abuts against said wheel seat.

10. The sunshade assembly as claimed in claim 1, wherein said driving unit includes:
a driving component disposed on said stationary seat; and
a pair of side bar connecting units connected pivotally between said driving component and said side bar member, each of said side bar connecting units including
a lower arm that is connected pivotally to said driving component, and
an upper arm that is connected pivotally between said lower arm and said side bar member.
